(19) United States
(12) Patent Application Publication
(10) Pub. No.: US 2005/0198572 A1
(43) Pub. Date: Sep. 8, 2005

(54) Method and system of printing isolated sections from documents

(75) Inventors: Marques Benjamin Quiller, Pflugerville, TX (US); Timothy Alan Dietz, Austin, TX (US); Lane Thomas Holloway, Pflugerville, TX (US)

Correspondence Address: International Business Machines;Intellectual Property Law, 11400 Burnet Road, Austin, TX, 78758, US

(73) Assignee: International Business Machines Corporation, Armonk, NY (US)

(21) Appl. No.: 10/777,725

(22) Filed: Feb. 12, 2004

(51) Int. Cl. G06F 17/24

(52) U.S. Cl. 715/527

(57) ABSTRACT

A system, method, and related computer program for isolating sections of data from a document for printing said designated data from received documents from the World Wide Web and like networks, or from documents such as pdf files, source code files, presentation, spread sheet, and Word documents. An interactive browser associated with each of the receiving stations in the network accesses received documents from the network and displays the documents at any receiving display station. The user is then able to isolate designated data and print only the designated data without the extraneous displayable data included in the received document. The browser further includes means for copying the designated data to create a secondary document having a document format structure which is independent of the format structure of the underlying received document. There is provided mean for storing this secondary document in association with the browser which is independent of said received Web document.

### TECHNICAL FIELD

The present invention relates to computer managed communication networks such as the World Wide Web (Web) and, particularly, to systems, processes and programs for printing isolated sections of documents received from the Web or documents that exist independently from the Web, such as pdf files, source code files, presentation, spread sheet, and Word documents.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

Also, as a result of the rapid expansion of the Web, E-mail, multimedia files and documents and real-time digital broadcastings, which have been distributed for over 25 years over smaller private and specific purpose networks, has moved into distribution over the Web because of the vastly improved server technology and channels that are available. The availability of extensive E-mail distribution channels had made it possible to keep all necessary parties in business, government and public organizations completely informed of all transactions that they need to know about at almost nominal costs.

However, in the era of the Web, we do not have the situation of a relatively small group of professional designers working out the human factors; rather, anyone and everyone can design a Web document or E-mail document structure. As a result, Web and E-mail documents are frequently set up and designed in an eclectic manner. This often results in extraneous test/image clutter and/or advertising on documents or E-mail received from the Web or like private networks. A similar problem exists with lengthy documents, such as pdf files, source code files, presentation, spread sheet, and Word documents, when the user needs to print a certain part of a document, but the printer prints the entire document.

It is often the case that the user who receives a Web document or E-mail, or the user of a pdf file, source code file, presentation, spread sheet, and Word document, wishes to just print the gist of the information thereon, and eliminate extraneous material when printing. For example, a lengthy document may contain a table of contents or headings. With the present invention, the user is able to right click on a chapter in the table of contents, or on a heading, and be provided with the option to “print section” from a pop-up menu. The user's printer would then print the chapter or section that correlates to the desired heading the user selected. This new method eliminates the time consuming task of determining the exact pages to print that correspond with the desired heading. This invention also saves the user paper which would otherwise be used to print unwanted extraneous material that surrounds the desired contents of the heading the user intended to print.

In another example, a user has ordered an item over the Web via E-mail. The user receives an E-mail with vital data such as the shipping date, carrier and tracking number. The E-mail also contains a lot of extraneous data of little current interest to the user, e.g., other products of shipper as well as interactive dialog boxes for ordering such other products. It is currently very difficult for the user to extract from the E-mail and print the vital data without the extraneous data. If the received E-mail document has the same document format structure, i.e., is created with a text processing program which is the same as the text processing program available at the user's receiving display station, then the same text processing program may be used to edit the received document or E-mail to eliminate the extraneous material.

Unfortunately, with the wide diversity of E-mail structure formatting programs on which Web documents and E-mail may be formatted at their respective sources, it is unlikely that a received document or E-mail would be formatted by a text processing program which is the same as that available at the receiving station. In addition, it is often difficult if not impossible for the receiving user to determine by what process the received document had been formatted.

With some text processing systems, there are available routines for converting documents with certain specified other format structures into documents having the format of the text processing system so that the documents may be processed by the instant system. Thus, under specified conditions with such programs, it may be possible to convert the received E-mail or other Web document into an appropriate format, and then edit the document to remove extraneous material. This would add a very undesirable complexity to the efforts of the average public or consumer user of the Web who may be assumed to have very limited data processing skills. In addition, it may often not be easy to determine the document format structure of a received Web document of E-mail so that even a sophisticated user would be able to effect a permitted document format transition, and then remove extraneous information.

### SUMMARY OF THE PRESENT INVENTION

The present invention provides a solution to the above recited problems by a system, method and related computer program for eliminating extraneous data from displayable received networks, e.g., Web documents and E-mail which are independent of the format structure of the received document, and from documents such as pdf files, source code files, presentation, spread sheet, and Word documents. The invention is operable in a communication network environment with user access via a plurality of data processor controlled interactive receiving display stations for displaying received documents of at least one display page, e.g. World Wide Web documents and E-mail containing formatted text and image data, and available from sources on the network. The system comprises interactive browser means associated with each of said receiving stations for accessing received documents from the network and displaying the documents at any receiving display station. This network browser includes means enabling a user to designate data in the underlying displayed document page required by the user. The browser further includes means for printing the designated data.

In accordance with another aspect of the invention, there is provided means for copying said designated data to create a secondary document having a document format structure independent of a format structure of the received document.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit that provides the computer controlled interactive display system that may be used in practicing the present invention;

FIG. 2 is a generalized diagrammatic view of a Web portion upon which the present invention may be implemented;

FIG. 3 is a diagrammatic view of a typical network document page displayed at a receiving display station;

FIG. 4 is the diagrammatic document page view of FIG. 3, after a user has selected a chapter to print;

FIG. 5 is an illustrative flowchart describing the setting up of the process of the present invention for isolating data for printing; and

FIG. 6 is a flowchart of an illustrative run of the process set up in FIG. 5.

### DETAILED DESCRIPTION OF THE PREFERRED EMBODIMENT

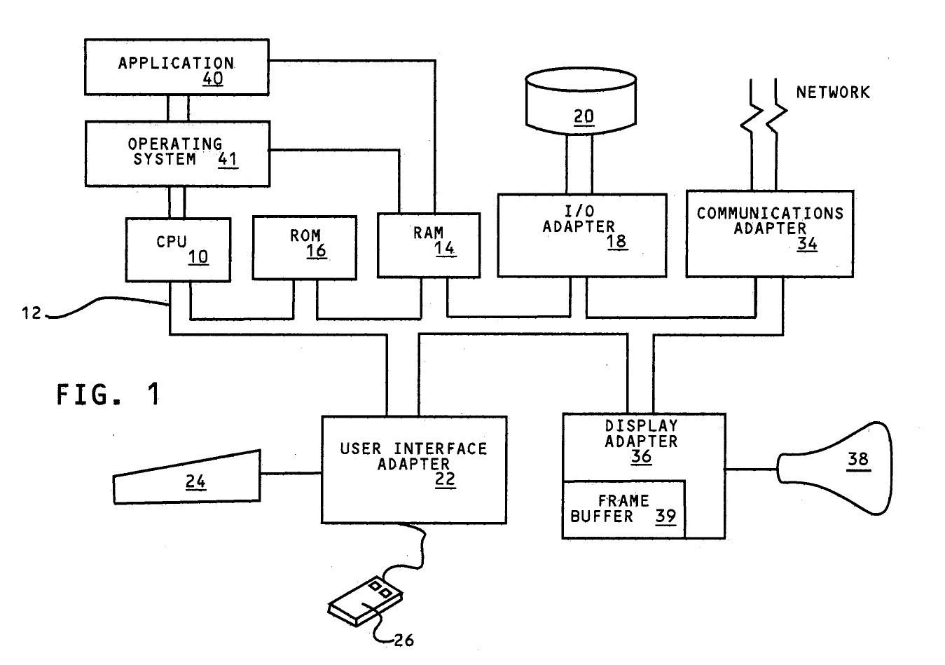

Referring to FIG. 1, a typical data processing terminal is shown which may function as the Web display station used for receiving Web pages, E-mail, browsing, and requesting Web documents from sources on the Web, or for displaying other received documents, such as pdf files, source code files, presentation, spread sheet, and Word documents. “Received documents” is described herein to mean Web pages, E-mail, browsing, and other Web documents from sources on the Web, as well as other documents received by some other source, like a computer disc, such as pdf files, source code files, presentation, spread sheet, and Word documents.

A central processing unit (CPU) 10, may be one of the commercial microprocessors in personal computers available from International Business Machines Corporation (IBM) or Intel Corporation; when the system shown is used as a server computer at the Web distribution site, to be subsequently described, then a workstation is preferably used, e.g. RISC System/6000™ (RS/6000) series available from IBM. The CPU 10 is interconnected to various other components by system bus 12. An operating system 41 runs on a CPU 10, provides control and is used to coordinate the functions of the various components of FIG. 1. Operating system 41 may be one of the commercially available operating systems such as IBM's AIX 5L™ operating system; Microsoft's Windows XP™; or Windows2000™, as well as other UNIX and AIX operating systems. Application programs 40, controlled by the system, are moved into and out of the main memory Random Access Memory (RAM) 14. These programs include the programs of the present invention for isolating sections of a document for printing. The programs will be subsequently described in combination with any conventional Web browser, such as the Netscape Navigator 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with the outside network enabling the data processing system to communicate with other such systems over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to Web documents. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents, such as Web pages transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks, as well as other documents, like pdf files, source code files, presentation, spread sheet, and Word documents that may or may not have been accessed from the Web or other networks, and is intended to include Web pages with displayable text, graphics and other images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such as MPEG, JPEG or GIF files, which are described in the text, Internet: The Complete Reference, Millennium Edition, Young et al., 1999, Osborne/McGraw-Hill, particularly at pp. 728-730.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers. The invention may involve the use of search engines for searching. As described in the above-mentioned Internet: The Complete Reference, Millennium Edition text, pages 395 and 522-535, search engines use key words and phrases to query the Web for desired subject matter.

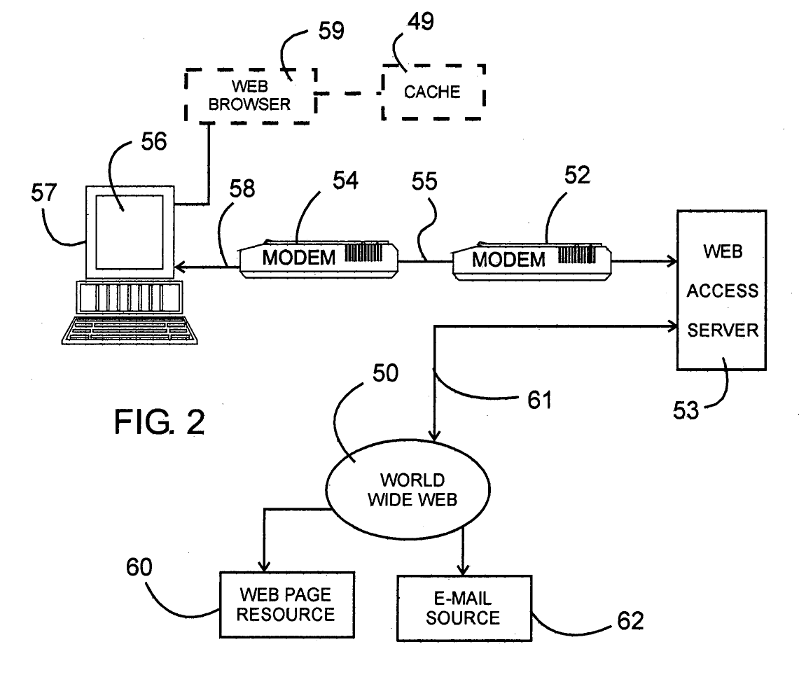

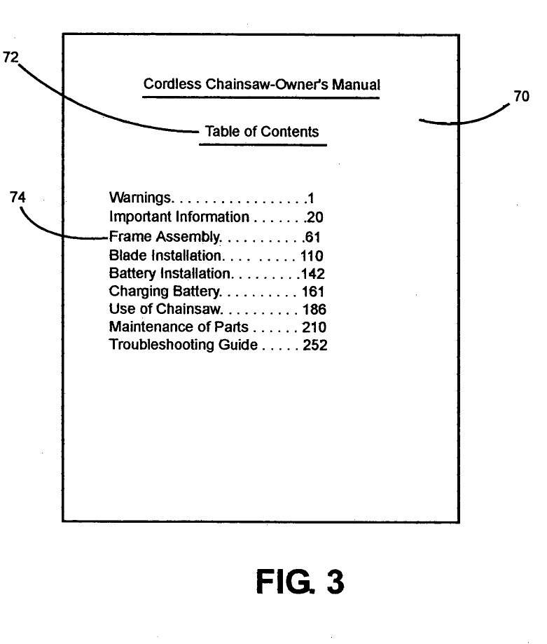

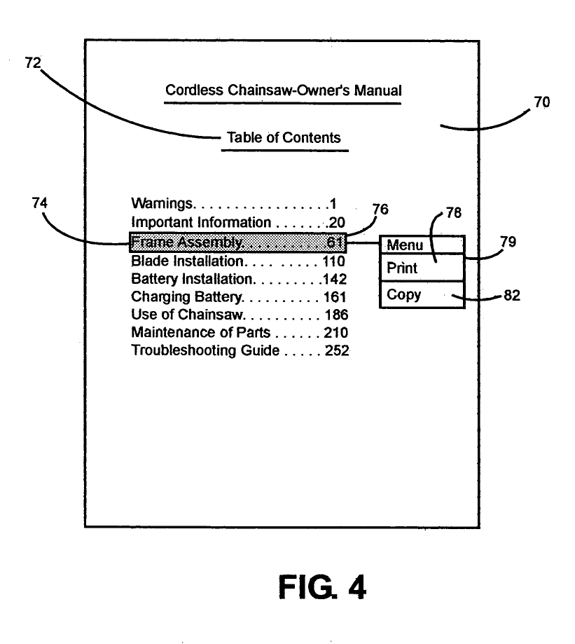

While the present invention may effectively be used in a private network environment, for convenience in illustration, a generalized portion of the Web as shown in FIG. 2 will be used. A generalized diagram of a portion of the Web, which the computer controlled display terminal 57 used for Web page receiving is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and is functioning running programs in a desktop or workspace environment on display 56. What is displayed may be electronic documents in the form of E-mail or other Web documents or pages, or other documents, such as pdf files, source code files, presentation, spread sheet, and Word documents. Reference may be made to the above-mentioned Mastering the Internet, pp. 136-147, for typical connections between local display workstations to the Internet via network servers, any of which may be used to implement the system on which this invention is used. The system embodiment of FIG. 2 is one of these known as a host-dial connection. Such host-dial connections have been in use for over 30 years through network access servers 53 which are linked 51 to the Internet 50. High speed cable modems are now replacing the telephone lines. The servers 53 are maintained by a service provider to the client's display terminal 57. The host's server 53 is accessed by the client terminal 57 through a normal dial-up telephone or high speed cable linkage 58 via modem 54, line 55 and modem 52. The files representative of the Web pages, E-mail or messages are downloaded to display terminal 57 through controlling server 53 via the telephone or cable line linkages from server 53 which has accessed them from the Internet 50 via linkage 61. Web browser 59 controls the Web page/E-mail accessing and messaging display functions being described including communications to and from sources 60 and 62 via Web 50. Browser 59 has an associated cache for temporary storage of documents and E-mail obtained from the network through the browser. Web server 53 will carry out the functions of obtaining the Web documents, pages, or sections of the documents as requested by the user via Web browser 59 and downloaded into storage in Web cache 49. With this setup, the present invention, which will be described in greater detail with respect to FIGS. 3 and 4, may be carried out using Web browser 59 and associated Web server 53 (FIG. 2). Now, with respect to FIGS. 3 and 4, we will give an illustrative example of how the present invention may be used to provide an implementation for isolating desired data for printing only the requested data from a lengthy document, such as a Web page, pdf file, source code file, presentation, spread sheet, or Word document. For purposes of this illustrative embodiment, assume that a lengthy document 70 containing a table of contents 72 or headings is displayed at a display station. The lengthy document 70 is an instruction manual and the user is only concerned with and only wants to print the important portion 74, Page 60, which describes how to assemble the apparatus for which it relates, and the user does not want to print the entire document.

Accordingly, as shown in FIG. 4, the user employs the standard graphics available with the operating system, e.g., Windows 2000 to highlight or likewise define 76 the important portion 74 of the document 70. One way for the user to do so is to right click the mouse on the desired chapter or heading of a document's table of contents 72, and a pop-up menu 79 is then provided to the user. The user can select “Print” 78 from the pop-up menu 79, and the chapter or heading indicated will be printed without printing the entire document 70. This indicates that the user intends to print 78 the portion 74, or extract and copy 82 the portion 74 into a separate document.

This extraction or copying may be defined at the display frame buffer during the display of the document 70. Referring back to basic display computer system of FIG. 1, display adapter 36 includes a frame buffer 39, which is a storage device that holds a representation of each pixel on the display screen 38. Frame buffer images may be stored in frame buffer 39 for display on monitor 38 on a number of frame levels. Accordingly, under control of the browser program, the defined 76 portion 74 of the document 70 to be extracted in FIG. 4 is scanned and directly copied from the underlying frame buffer layer containing the whole document 70 into an overlaying frame buffer layer containing only the desired portion 74. This function utilizes the conventional ability of the browser to render the received document or Web page images into frame buffer layer pixel array image for the whole original document, the defined information to be extracted into the secondary may be readily lifted and stored separately within the browser cache. Since the pixel array image of the original document is wholly independent of the document format structure of this original document, the extracted pixel array image of this secondary document will also be independent.

As a result, there are two separate documents: the whole basic document 70 available at one level in the frame buffer, and the extracted or copied selected information 74 available as an independent secondary document at a different frame buffer overlying layer. The primary and secondary documents may then be stored at least temporarily in the cache 49 of browser 59 (FIG. 1), and either may be displayed and/or printed as desired. When printed, the secondary documents containing only necessary information will reduce costs by eliminating the printing of extraneous information. In addition, since the secondary document is stored on the Web browser cache as pixel mapped document, it may then be converted into any document structure format should it be desired to edit the secondary document in any way.

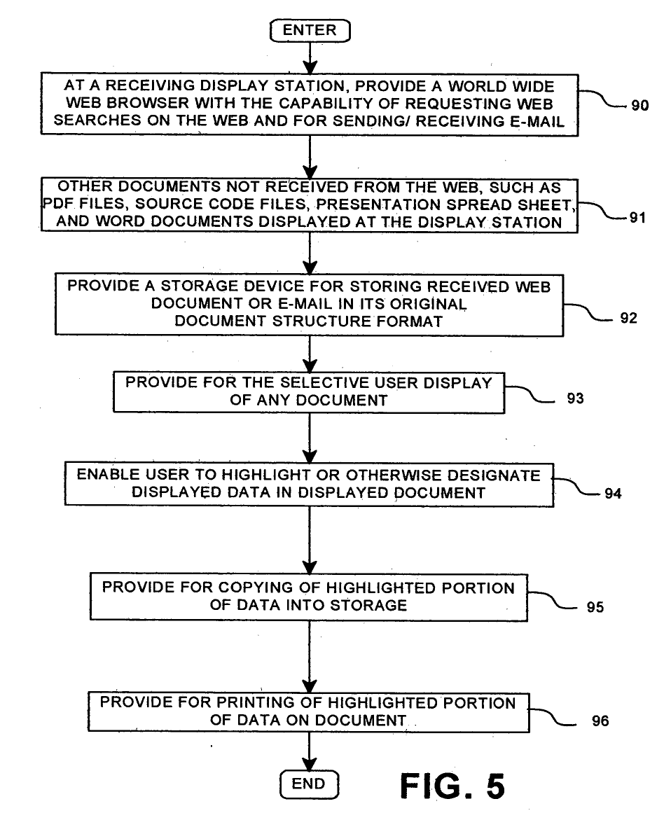

FIG. 5 is a flowchart showing the development of a process according to the present invention for isolating desired data for printing. Most of the programming functions in the process of FIG. 5 have already been described in general with respect to FIGS. 3 and 4. A Web browser is provided at a receiving display station on the Web for accessing Web pages and E-mail, step 90, in the conventional manner and loading them at the display station, step 91. Other documents not received from the Web, such as pdf files, source code files, presentation, spread sheet, and Word documents, can also be displayed at the display station, step 91. The Web pages are conventionally obtained via a Web server provided by an ISP. The Web browser has the capability of requesting searches from one or more search engines available through the Web. There is provided in association with the browser a conventional storage device, e.g., cache for storing the received Web document or E-mail in its original document structure format, step 92. Under the browser control, there is provided for the conventional display of received Web documents and E-mail which would be stored on the browser cache, step 93. Provision is made to enable the user to selectively highlight of otherwise designate portions of data in the displayed E-mail, Web page, or other documents, such as pdf files, source code files, presentation, spread sheet, and Word documents, step 94. Provision is made for the copying of the highlighted portions of data into storage, step 95, separate from the storage of the received E-mail, Web document, or other documents of step 92, and in document structure format independent of the structure format of the E-mail or Web document. The user can simply highlight the desired chapter or heading from a table of contents in a document, right click on the mouse, and select “Print” from a pop-up menu, step 96. The user is enabled, to print the data stored in step 95 independent of the original received E-mail, Web document, or other document.

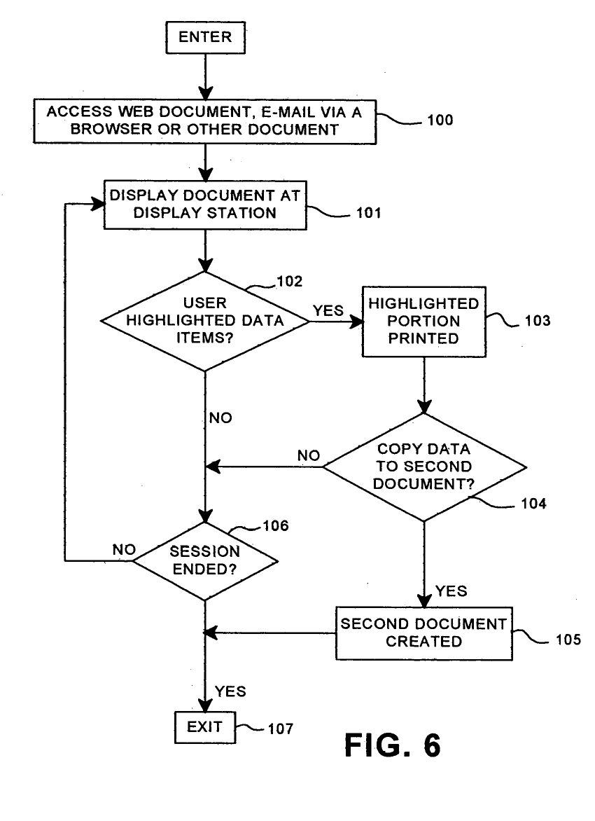

The running of the process set up in FIG. 5 and described in connection with FIGS. 3 through 5 will now be described with respect to the flowchart of FIG. 6. The flow chart represents some steps in a routine that will illustrate the operation of the invention. The browser, via a Web access server, accesses the pages found by a search engine or receives an E-mail, step 100. The display station displays the document (Web page, E-mail, or other document, such as a pdf file, source code file, presentation, spread sheet, or Word document), step 101. During the display of this document, a determination is made as to whether the user has highlighted any data items on the displayed document so that the user may isolate the data for printing, step 102. If Yes, the desired portion of the document is printed, step 103. Then, a determination is made as to whether the user has requested the isolated data be copied into a second document containing only the isolated data, step 104. If Yes, the second document is created, step 105. If No, or if the decision from step 102 had been No, a further determination is made as to whether the session is at an end, step 106. If Yes, the session is exited, step 107. If No, then the process is branched back to step 101 where the next document is displayed.

One of the preferred implementations of the present invention is in application program 40 made up of programming steps or instructions resident in RAM 14, FIG. 1, of Web server computers during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. In a communication network with user access via a plurality of data processor controlled interactive receiving display stations for displaying received documents of at least one display page containing formatted text and image data, and available from sources on the network, a system for eliminating extraneous displayable data from received documents comprising:
network interactive browser means associated with each of said receiving stations for accessing said received documents from the network and displaying said documents at said receiving display stations;
said network browser means further including:
means for isolating data in a displayed received document using divider tags;
means enabling a user to print the isolated data designated by a user; and
means for copying said designated data to create a secondary document having a document format structure independent of a format structure of the received document.

2. The communication network of claim 1 wherein said communication network is the World Wide Web (Web), and said network documents are Web documents.

3. The Web network of claim 2 wherein said documents are E-mail documents.

4. The Web network of claim 3 further including means for storing said secondary document independent of said received Web document.

5. The Web network of claim 2 wherein there are uncopied extraneous graphics and text remaining in said underlying Web document.

6. The Web network of claim 3 wherein there are unprinted extraneous graphics and text in said underlying Web document.

7. In a communication network with user access via a plurality of data processor controlled interactive receiving display stations for displaying received documents of at least one display page containing text and images, and available from sources on the network, a method for eliminating extraneous displayable data from received documents comprising:
a network interactive browser process associated with each of said receiving stations for accessing said received documents from the network and displaying said documents at said receiving display stations;
said network browser process further including the steps of:
isolating data in a displayed received document using divider tags;
enabling a user to print the isolated data designated by a user; and
copying said designated data to create a secondary document having a document format structure independent of a format structure of the received document.

8. The method of claim 7 wherein said communication network is the World Wide Web (Web), and said network documents are Web documents.

9. The method of claim 8 wherein said documents are E-mail documents.

10. The method of claim 9 further including the step of storing said secondary document independent of said received Web document.

11. The method of claim 8 wherein there are uncopied extraneous graphics and text remaining in said underlying Web document.

12. The method of claim 9 wherein there are unprinted extraneous graphics and text in said underlying Web document.

13. A network browser computer program having code recorded on a computer readable medium associated with each of said receiving stations for eliminating extraneous displayable data from received documents in a communication network with user access via a plurality of data processor controlled interactive receiving display stations for displaying received documents of at least one display page containing text and images, and available from sources on the network, for printing, said browser program comprising:
means for accessing said received documents from the network and
displaying said documents at said receiving display stations;
means for isolating data in a displayed received document using divider tags;
means enabling a user to print the isolated data designated by a user; and
means for copying said designated data to create a secondary document having a document format structure independent of a format structure of the received document.

14. The computer program of claim 13 wherein said communication network is the World Wide Web (Web), and said network documents are Web documents.

15. The computer program of claim 14 wherein said documents are E-mail documents.

16. The computer program of claim 15 further including means for storing said secondary document independent of said received Web document.

17. The computer program of claim 14 wherein there are uncopied extraneous graphics and text remaining in said underlying Web document.

18. The computer program of claim 15 wherein there are unprinted extraneous graphics and text in said underlying Web document.
